(19) United States
(12) Patent Application Publication
(10) Pub. No.: US 2004/0038003 A1
(43) Pub. Date: Feb. 26, 2004

(54) Label having ground sunken letters and/or designs and its manufacturing method

(76) Inventor: Jong Sool Jang, Seoul (KR)

Correspondence Address: THOMAS R. FITZGERALD, ESQ., 16 E. MAIN STREET, SUTIE 210, ROCHESTER, NY, 14614-1803, US

(21) Appl. No.: 10/356,123

(22) Filed: Feb. 3, 2003

(30) Foreign Application Priority Data
Aug. 23, 2002 (KR) 10-2002-0050202

(51) Int. Cl. B32B 3/00; B05D 1/36

(52) U.S. Cl. 428/156; 427/258; 427/407.1

(57) ABSTRACT

A label having sunken letters and/or designs and its manufacturing method are disclosed. The label according to the present invention comprises a sunken solidified layer for forming non-protruding letters and/or designs therein at bottom surface of the protrusion label; and a solidified sheet for forming a ground of the label in such a manner that the sunken solidified layer is formed therein. The label has a long life, easily expresses background colors, letters and/or designs of various types, shows beautiful appearance as it does not have the protrusion, has wide application, and can be produced on a large scale as being easy in the manufacturing process and having a good economical efficiency.

### BACKGROUND OF THE INVENTION

1. Field of the Invention

The present invention relates to a label including letters and/or designs therein and particular to a label having ground sunken letters and/or designs and manufacturing method thereof.

2. Background of the Related Art

Generally, a label is attached on an exterior surface of a product or a package to show its specification. The label functioning like the above may be classified into a silicon label, a high-frequency rubber label, a printed high-frequency label, a high-frequency fixed label, a metal label, and so on, according to a manufacturing methods or materials. In this application, a label made of a whole rubber will be treated.

First of all, the terminologies described in the present application are defined as below:

‘A label protrusion’ means a fore mostly protruded part from bottom ground formed by a base sheet. Here, the label protrusion forms letters and/or designs. ‘A middle ground’ means a part placed between the bottom ground and the label protrusion. The middle ground forms the label protrusion thereon with respect to the bottom ground or does not form.

Here, the label protrusion, the middle ground and the bottom ground are defined as a relative concept.

‘A first engraved part’ means a deepest engraved part in a mold for correspondingly forming the label protrusion. ‘A second engraved part’ is a part of a mold for correspondingly forming the middle ground, which does not form the label protrusion. The second engraved part is a secondly deeper part if the mold has the first engraved part. However, the second engraved part may become a first engraved part if it forms letters and/or designs thereon and it is formed on the bottom ground. ‘A third engraved part’ is an engraved part of the mold for correspondingly forming the bottom ground of the label, and is engraved relatively shallowly in the mold.

‘A first solidified layer’ is a layer made of paste PVC resin compound for forming letters and/or designs. The first solidified layer corresponds to the label protrusion. ‘A second solidified layer’ is a layer made of paste PVC resin compound for expressing non-protruding letters and/or designs.

Additionally, ‘stencil printing’ is to form holes such as letters and/or designs in a film, and is used for printing shapes of the letters and/or designs through the holes of the film by coating resin on the mold located under the film.

FIG. 1 is a schematic view of a conventional label.

As shown in FIG. 1, the label L1 comprises a label protrusion 5 including letters, LA, a middle ground 6 including the label protrusion 5 thereon and a sheet 7 including the middle ground 6 thereon. Here, the label is made of a whole rubber. Also, the label L1 can form designs on the label protrusion 5 instead of the letters or form the letters and/or designs at the same time.

Here, the label L1 is manufactured from a whole rubber that is made of paste PVC resin.

The label L1 structured above is manufactured as below:

FIGS. 2A to 2D are schematic views for explaining a manufacturing process of the conventional label L1 of FIG. 1.

As shown in FIG. 2A, assume that a mold 4 previously engrave a first engraved part 1 deepest patterned therein, a second engraved part 2 secondly deeper patterned therein and a third engraved part 3 the most shallow patterned therein, which correspond to the label protrusion 5, the middle ground 6 and the sheet 7, respectively.

Now, in order to manufacture the label L1 including the letters, LA, as shown in FIG. 2B, the liquid type paste PVC resin is coated on the first engraved part 1 having letters, LA, and heated, solidified and cooled to form the protruding letters LA of the label L1 (Step S1). After forming the letter LA of the protrusion label, as shown in FIG. 2C, the liquid type paste PVC resin is coated on the second engraved part 2, and heated, solidified and cooled to form the middle ground 6 of the label L1 (Step S2). After that, as shown in FIG. 2D, the liquid type paste PVC resin is coated on the third engraved part 3 patterned the most shallow in the mold 4, and coated, heated, solidified and cooled to form the sheet 7 of the bottom ground (Step S3).

Alternatively, the manufacturing process may be modified not to include the step of forming the middle ground 6 or may be include the step of forming two or more of middle grounds 6.

Further, it is modified to include a step of making depressed letters and/or designs in the middle ground 6. Namely, the depressed letters and/or designs are formed in the middle ground 6 by a mold of which the bottom surface forms the corresponding letters and/or designs to be protruded to the opposite direction of the label protrusion 5.

Here, each engraved part of the mold 4 may be previously sanded to increase brilliance and definition of the surface of the manufactured label L1.

Meanwhile, the sheet 7 is manufactured by the steps of stirring the powder type paste PVC resin and DOP (DiOctyl Phthalate) in a ratio of 1:1 (there is a difference in the ratio according to a kind of products), coating the mixture on a mold, and heating, solidifying and cooling the mixture.

The paste PVC resin is charged into a mold in a liquid state, and during the step of stirring the liquid type paste PVC resin, pigment may be put into the paste PVC resin to form colored letters and/or designs.

To express senses of beauty of various types and to meet the demand, besides the letters and/or designs 5 protruding from the front of the label L1, it is necessary to form letters and/or designs also on the middle ground 6 or the sheet 7 of the bottom ground of the label. At this time, it is necessary to form the letters and/or designs in colors to be a colorful background, and to make their forming step simple not to raise a manufacturing cost.

However, conventionally, the paste PVC resin is poured into an engraved part of the mold 4, which is patterned previously, to form the protruding letters and/or designs 5 and the ground of the label L1. So, it is difficult to form additional background letters and/or designs on the ground of the label L1. Because the conventional method for manufacturing the label L1 is limited to a previously determined patterns of the mold 4, it has several disadvantages that it is difficult to express letters and/or designs of various types in the ground, it takes lots of time to work, and an economical efficiency is lowered.

Further, in order to manufacture a label having background letters and/or designs, even if the label manufacturing method according to the prior art includes a step for additionally printing letters or design to the bottom side of the manufactured label L1 having a transparent sheet, the printing step is additionally applied to the bottom surface of the finished label L1 product and the life of the label is reduced because the printed ink layer does not have a strong adhesive force to the resin solidified layer.

### SUMMARY OF THE INVENTION

Accordingly, the present invention is directed to a label having ground sunken letters and/or designs and its manufacturing method that substantially obviate one or more problems due to limitations and disadvantages of the related art.

An object of the present invention is to provide a label having ground sunken letters and/or designs and its manufacturing method, which can easily express background letters and/or designs of various types sunken in a ground without any protrusion and without coming off.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above objects of the present invention, there is provided a label having ground sunken letters and/or designs, the label comprising: a sunken solidified layer for forming non-protruding letters and/or designs therein at bottom surface of the protrusion label; and a solidified sheet for forming a ground of the label in such a manner that the sunken solidified layer is formed therein.

Also, there is a method for manufacturing a label having a first sunken letters and/or designs, wherein the method comprising the steps of: forming the first sunken letters and/or designs, including: coating a resin on a first film previously formed corresponding first sunken letters and/or designs as a penetrated pattern, the first film is placed at a predetermined position on bottom surface of a mold; solidifying the resin coated on the resin passing through the first film; and forming a solidified sheet, including: coating the resin on the first sunken letters and/or designs with a predetermined thickness; and solidifying the resin coating the first sunken letters and/or designs.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view of a conventional label;

FIGS. 2A to 2D are schematic views of a conventional label manufacturing process;

FIG. 3 is a schematic view of a label according to a preferred embodiment of the present invention;

FIG. 4 is a schematic view of a mold of the present invention;

FIG. 5 is a schematic view of a first film used for manufacturing the label according to the embodiment of the present invention; and

FIG. 6 is a schematic view of a second film used for manufacturing the label according to the embodiment of the present invention.

FIGS. 7A to 7I are schematic views of a label manufacturing process according to the present invention;

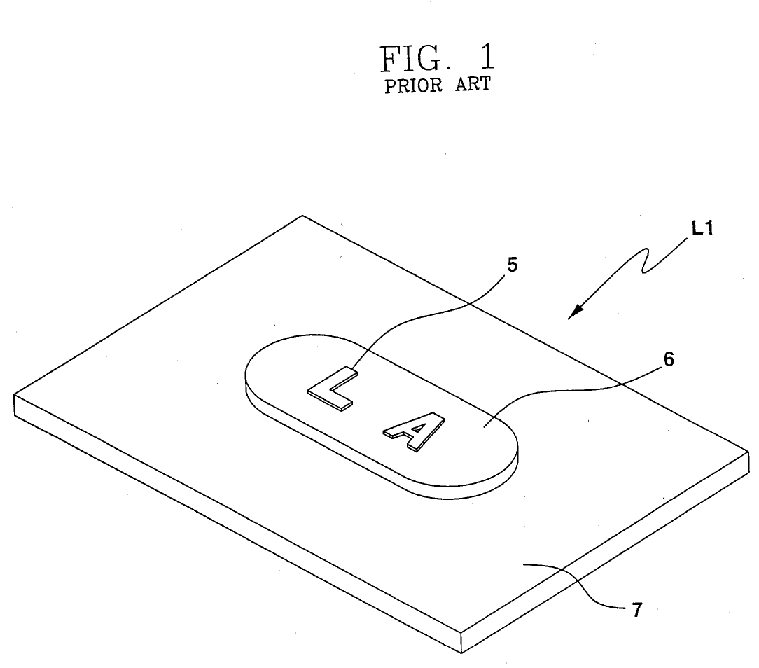

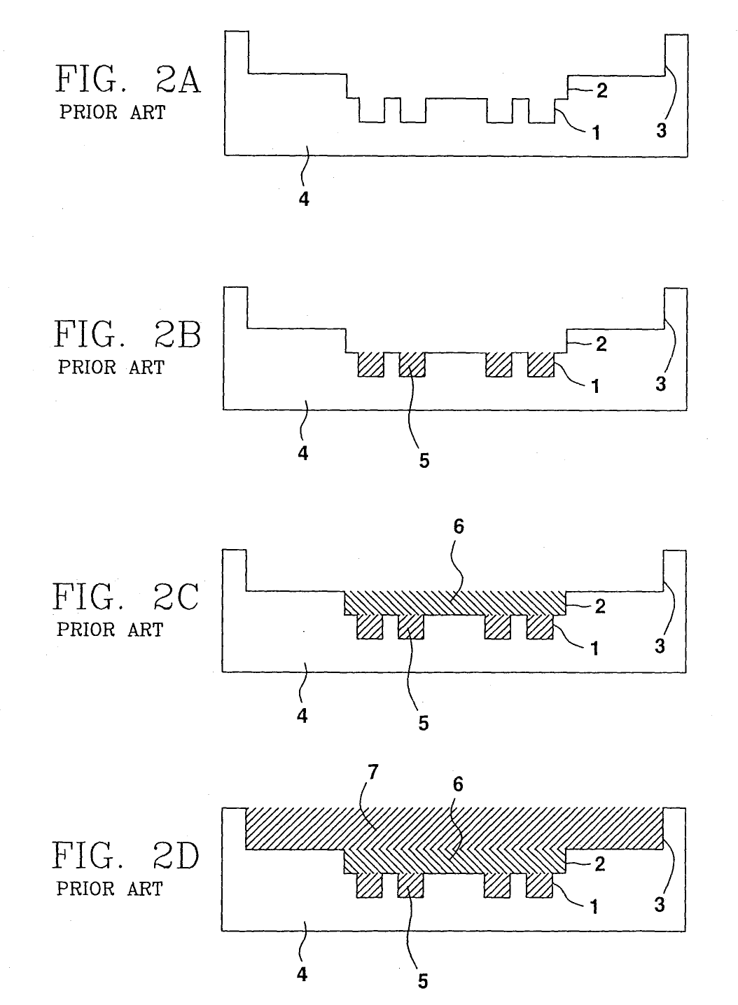

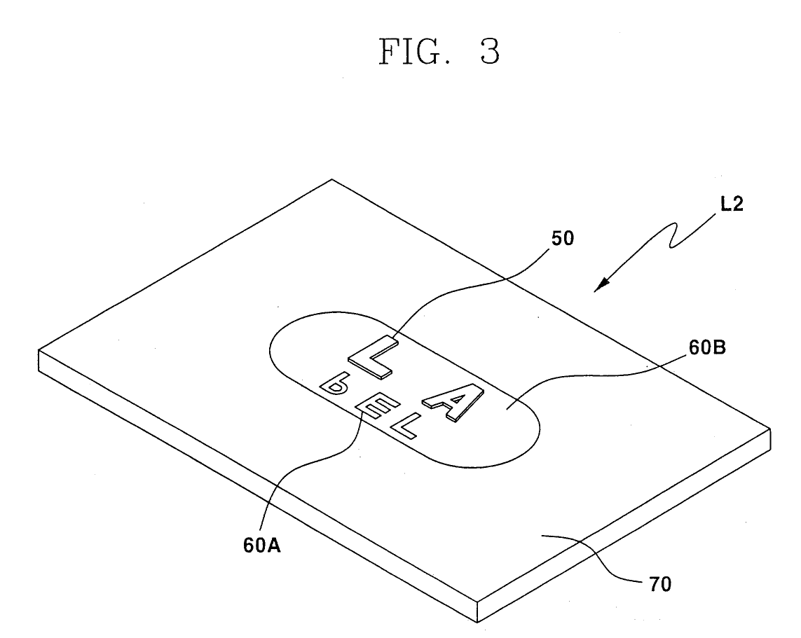

### DETAILED DESCRIPTION OF THE PREFERRED EMBODIMENT

Reference will now be made in detail to the preferred embodiments of the present invention, examples of which are illustrated in the accompanying drawings.

FIG. 3 is a schematic view of a label according to a preferred embodiment of the present invention.

As shown in the drawing, the label L2 comprises the protrusion label 50 forming protruded letters and/or designs thereon, for example, LA, a first sunken solidified layer 60A forming a first middle background letters and/or designs, for example, bel, a second sunken solidified layer 60B forming a second middle background letters or design, for example, a capsule shaped design and a solidified sheet 70.

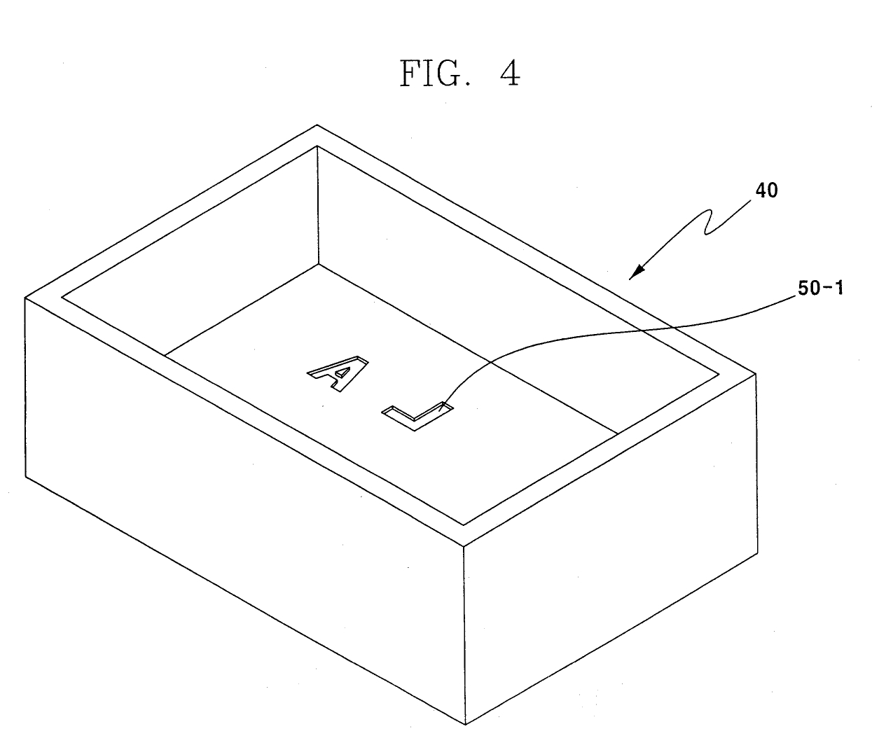

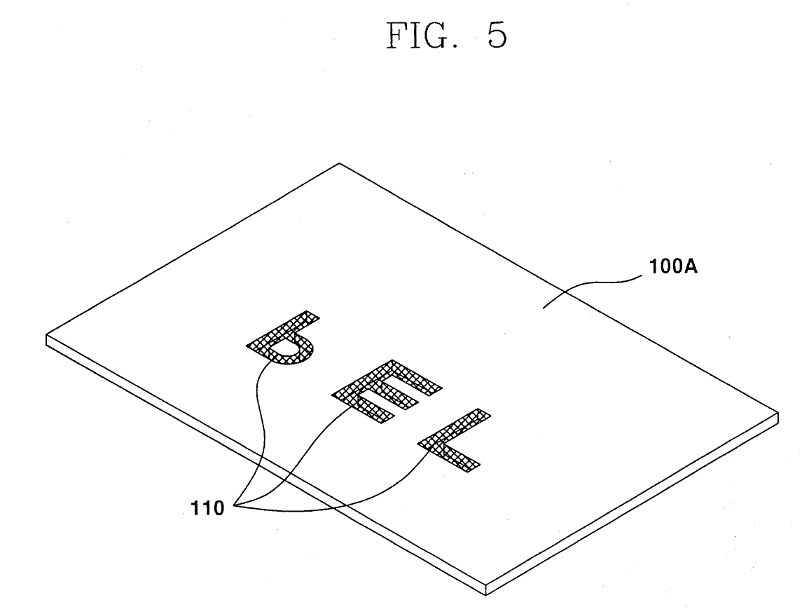

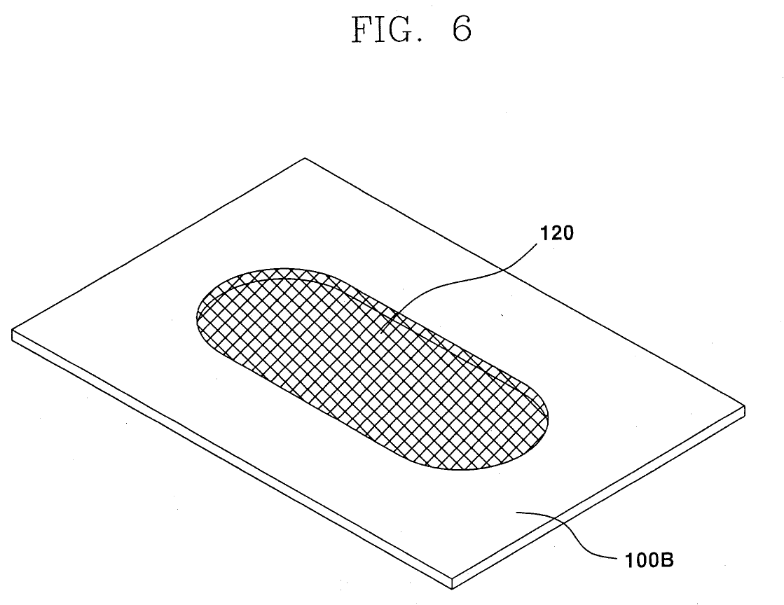

Here, the protrusion label 50 is formed by engraved letters engraved in a mold 40 as shown in FIG. 4, and the first sunken solidified layer 60A and the second sunken solidified layer 60B are formed by a first film 100A as shown in FIG. 5 and a second film 100B as shown in FIG. 6, respectively, which will be more explained in detail below.

FIG. 4 illustrates a schematic view of the mold 40 of the present invention in which the letters, LA, are engraved on the bottom surface thereof, which is called as an engraved part 50-1. Therefore, if the label L2 is manufactured, it has the letters protruded.

FIG. 5 is a schematic view of a first film 100A, and FIG. 6 is a schematic view of a second film 100B.

The first and the second film comprise the letters, bel, and the capsule shaped design thereon as the shapes corresponding to the letters or the design are penetrated therethrough. Also, as shown in the drawings, the first and the second films 100A and 100B can be implemented as a textile fabrics capable of passing a paste PVC resin compound may be attached over the hole as a penetrated pattern, on which the desired letters 110, bel, or the capsule shaped design 120. Therefore, the letters or designs are stencil-printed. Here, the textile fabric is preferably implemented by a silk.

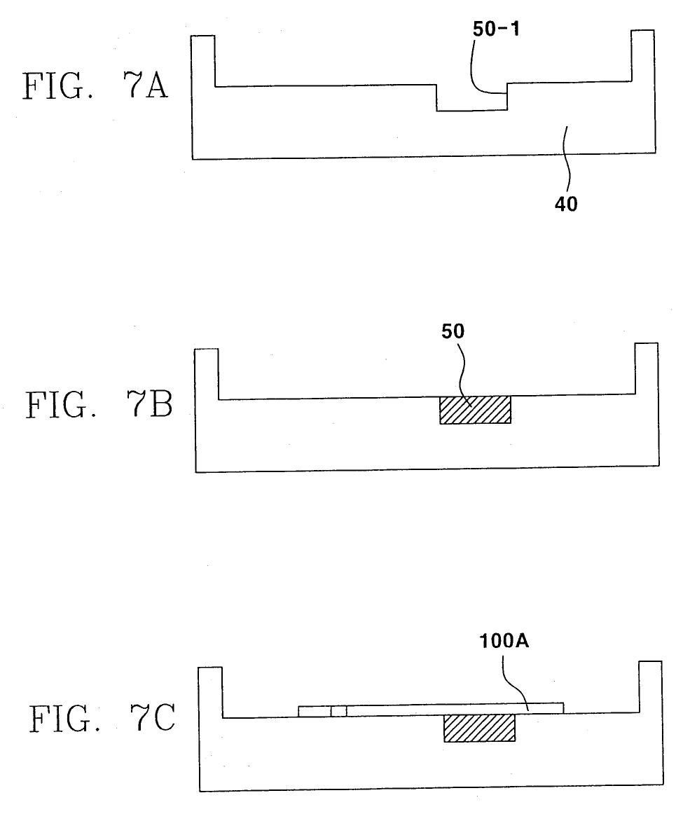

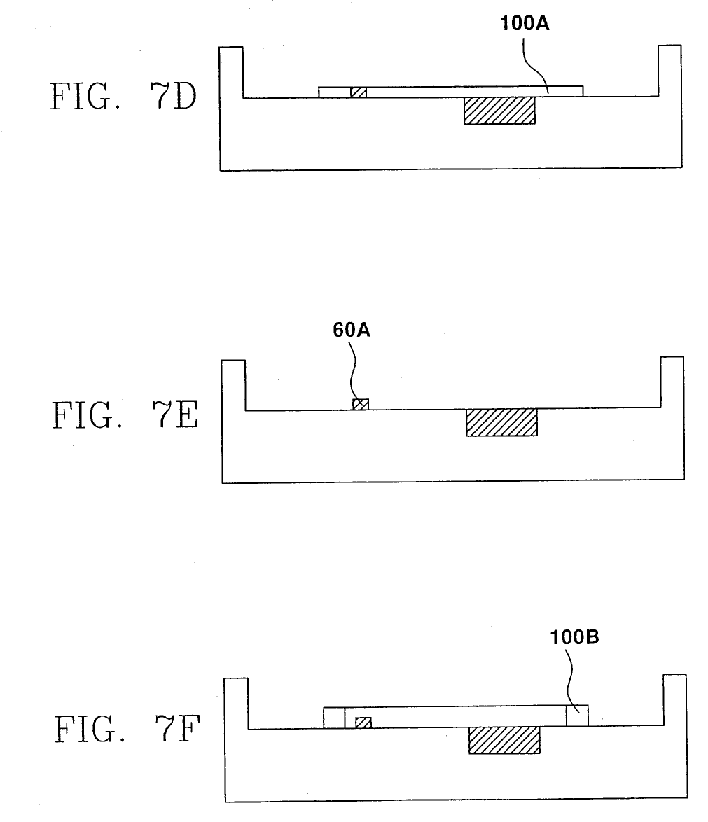

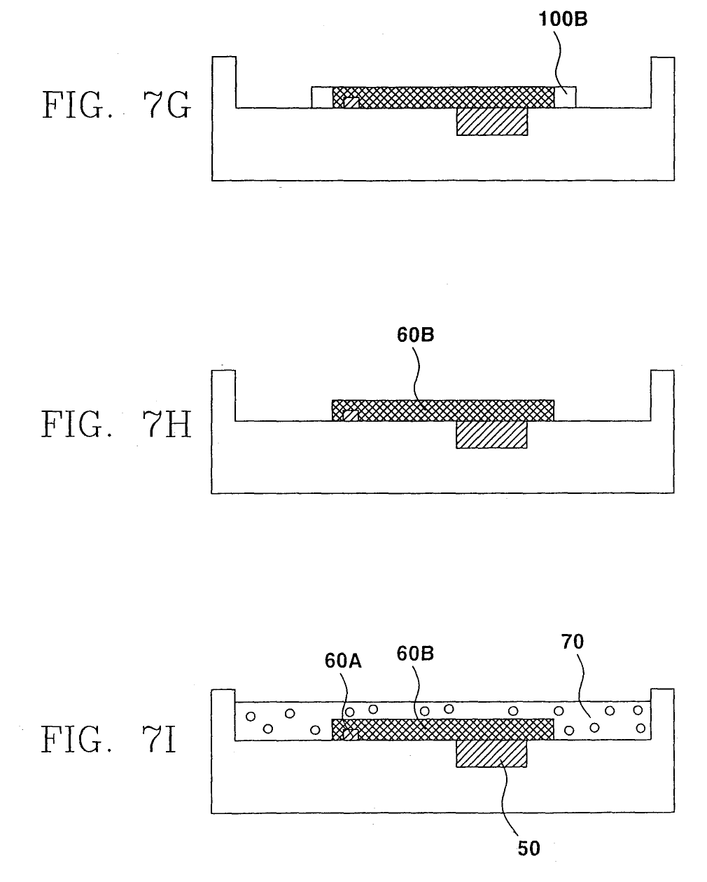

Referring the drawings, FIGS. 7A to 7I, the label manufacturing method according to the present invention will be explained in detail below.

FIGS. 7A to 7I are schematic views of a label manufacturing process according to the present invention.

First of all, in order to form the protrusion label 50, the engraved part 50-1 of the mold 40 as shown in FIGS. 7A and 7B cross-sectional view thereof is coated or filled with paste PVC resin compound and then it is heated, solidified and cooled. Therefore, the protruded letters, LA, is formed (Step 1).

After that, in order to form the first sunken solidified layer 60A, as shown in FIG. 7C, the first film 100A of FIG. 5 is placed at a predetermined position in the mold 40 covering the protrusion label 50. Then, as shown in FIG. 7D, the first film 100A is coated with a paste PVC resin compound to pass therethrough and is detached from the bottom of the mold 40. Then, the resin past through the first film 100A and remained on the mold is performed a solidifying process such as heating and cooling, thereby forming the first sunken solidified layer 60A of the label L2, as shown in FIG. 7E. Here, the letters, beg, are previously formed in the first film 100A and are stencil-printed, thereby forming the first middle background letters (Step 2-1).

In order to form the second sunken solidified layer 60B shaped a capsule, the second film 100B of FIG. 6 is placed at a predetermined position in the mold 40 as shown in FIG. 7F. Here, the second film 100B may cover the first sunken solidified layer 60A and the protrusion label 50. Then, as shown in FIG. 7G, the second film 100B is coated with a paste PVC resin compound to pass therethroug and is detached from the bottom of the mold 40. Then, the resin past through the second film 100B and remained on the mold is performed a solidifying process such as heating and cooling, thereby forming the second sunken solidified layer 60B of the label L2, as shown in FIG. 7H. Similar to the first film 100A, the second film 100B stencil-prints the capsule shaped design and form the second middle background design (Step 2-2).

Finally, in order to form the solidified sheet 70, paste resin compound is coated to cover the second sunken solidified layer 60B, the first sunken solidified layer 60A and the protrusion label 50 with a predetermined thickness. After that, it is heated, solidified and cooled. Therefore, the label L2 as shown in FIG. 3 is manufactured after separating from the mold 40 (Step 3).

Further, the solidified sheet 70 is cut to properly apply on a surface of a product or package.

Alternatively, a label can be manufactured without the protrusion label 50, which was not shown. Namely, the label L2′ without the protrusion label includes a sunken solidified layer which is corresponding to the first or the second sunken solidified layer 60A or 60B of the label L2 and made of paste PVC resin compound formed in the mold 40 after passing through a film corresponding to the first or the second film 100A or 100B of the label L2, in which the desired letters and/or designs are stencil-printed, and a solidified sheet of paste resin compound covering the sunken solidified layer. The label L2′ structured above is manufactured as below.

First of all, the film having desired letters and/or designs is paced on the bottom of the mold without an engraved part for protrusion label. Next, a liquid type paste PVC resin compound is coated on the film to make the compound pass the printed part, and then the film is removed from the mold. After that, the liquid PVC resin compound is performed a solidifying process such as heating and cooling to form desired non-protruding letters and/or designs (Step 10).

After the procedures, a liquid type paste PVC resin compound covers or coats the non-protruding letters and/or designs formed on the mold. Next, the resin is heated, solidified and cooled to form the solidified sheet (Step 20).

Therefore, the label L2′ is manufactured after separating from the mold. Further, the solidified sheet is cut according to a user's desired shape.

The sunken solidified layer of the paste PVC resin compound is integrally 0o sunken in the solidified sheet 70 of the paste PVC resin compound, which is the ground of the label L2′, without protruding to the front of the label L2′. Therefore, the label L2′ can be manufactured thin, and the desired background letters and/or designs, especially, colored letters and/or designs can be formed only through the film without any additional mold 40 or bottom printing. Furthermore, there is no possibility that the letters and/or designs come off.

The label according to the present invention can be used on products of many kinds requiring decoration or discrimination of products as it has wide application. Especially, the label can be used on products, such as hats, gloves, wallets, clothes or the likes, regarded very important in design, due to its easiness in beauty creation.

The label having the ground sunken letters and/or designs can easily form desired letters and/or designs by printing the film on the mold using the same compound as the protrusion and the ground.

The label according to the present invention has a long life, easily expresses background colors, letters and/or designs of various types, shows beautiful appearance as it does not have the protrusion, has wide application, and can be produced on a large scale as being easy in the manufacturing process and having a good economical efficiency.

As a modification of the present invention, other letters and/or designs, especially colored letters and/or designs, can be expressed on the label by using additional films.

As another modification of the present invention, other resin, such as silicon resin, can be used in the label, besides the liquid type paste PVC resin compound.

As another modification, additional members, such as a Velcro fastener, an adhering part, or others, may be used.

What is claimed is:

1. A label having ground sunken letters and/or designs, the label comprising:
a sunken solidified layer made of a resin for forming non-protruding letters and/or designs therein at bottom surface of the protrusion label; and
a solidified sheet made of the resin for forming a ground of the label in such a manner that the sunken solidified layer is formed therein.

2. The label according to claims 1, further comprising another sunken solidified layer for forming non-protrusion letters and/or designs between the sunken solidified layer and the solidified sheet.

3. The label according to claim 1, wherein the resin is selected in the same resin compound of PVC, silicon or selected differently each other.

4. The label according to claim 1, wherein the letters and/or designs in the sunken solidified layer are formed in colors.

5. The label according to claims 1, further comprising a protrusion label including letters and/or designs on the sunken solidified layer, the protrusion label is protruded from a outer surface of the sunken solidified layer.

6. The label according to claim 5, wherein the resin is selected in the same resin compound of PVC, silicon or selected differently each other.

7. The label according to claims 5, further comprising another sunken solidified layer for forming non-protrusion letters and/or designs between the sunken solidified layer and the solidified sheet.

8. The label according to claim 7, wherein the resin is selected in the same resin compound of PVC, silicon or selected differently each other.

9. The label according to claim 5, wherein the letters and/or designs in the sunken solidified layer are in colors.

10. A method for manufacturing a label having a first sunken letters and/or designs, wherein the method comprising the steps of:
forming the first sunken letters and/or designs, including:
coating a resin on a first film previously formed corresponding first sunken letters and/or designs as a penetrated pattern, the first film is placed at a predetermined position on bottom surface of a mold;
solidifying the resin coated on the resin passing through the first film; and
forming a solidified sheet, including:
coating the resin on the first sunken letters and/or designs with a predetermined thickness; and
solidifying the resin coating the first sunken letters and/or designs.

11. The method according to claim 10, wherein said solidifying comprising heating the resin and cooling the same.

12. The method according to claim 10, further comprising a step of forming a second sunken letters and/or designs, including:
coating the resin on a second film previously formed corresponding the second sunken letters and/or designs as a penetrated pattern, the second film is place at a predetermined position on the solidified resin forming the first sunken letters and/or designs so that the second sunken letters and/or designs are aligned to the predetermined position with respect to the first sunken letters and/or designs; and
solidifying the resin past through the second film.

13. The method according to claim 12, wherein said solidifying comprising heating the resin and cooling the same.

14. The method according to claim 12, further comprising a step of forming protruding letters and/or designs, including:
coating the resin on a engraved part formed within the mold before forming the first sunken letters and/or designs, the engraved part is previously engraved like corresponding protruding letters and/or designs on a bottom surface of the mold; and
solidifying the resin coated on the engrave part.

15. The method according to claim 14, wherein said solidifying comprising heating the resin and cooling the same.

16. The method according to claim 10, further comprising a step of forming protruding letters and/or designs, including:
coating the resin on a engraved part formed within the mold before forming the first sunken letters and/or designs, the engraved part is previously engraved like corresponding protruding letters and/or designs on a bottom surface of the mold; and
solidifying the resin coated on the engraved part.

17. The method according to claim 15, wherein said solidifying comprising heating the resin and cooling the same.
